(19) United States
(12) Patent Application Publication
(10) Pub. No.: US 2010/0047697 A1
(43) Pub. Date: Feb. 25, 2010

(54) LEAD-ZINC BATTERY

(76) Inventor: John E. Stauffer, Greenwich, CT (US)

Correspondence Address: YOUNG BASILE, 3001 WEST BIG BEAVER ROAD, SUITE 624, TROY, MI, 48084, US

(21) Appl. No.: 12/608,201

(22) Filed: Oct. 29, 2009

Related U.S. Application Data
(63) Continuation-in-part of application No. 11/249,223, filed on Oct. 13, 2005.
Application No. 11/249,223 is a continuation-in-part of application No. 10/756,015, filed on Jan. 13, 2004, now abandoned.
Application No. 10/756,015 is a continuation-in-part of application No. 11/167,535, filed on Jun. 27, 2005.
Application No. 11/167,535 is a continuation-in-part of application No. 10/756,015, filed on Jan. 13, 2004, now abandoned.

(51) Int. Cl. H01M 10/26; H01M 6/04

(52) U.S. Cl. 429/347; 429/206

(57) ABSTRACT

A rechargeable battery is provided such that the positive electrode companies lead, the negative electrode zinc, and the electrolyte is an aqueous solution of an alkali metal sulphate. Upon discharge, lead dioxide is reduced to lead sulphate and zinc is oxidized to zinc oxide. The reactions are reversed when the battery is charged.

### RELATED APPLICATIONS

This application is a continuation-in-part of U.S. application Ser. No. 11/249,223 filed on Oct. 13, 2005 currently pending, which in turn is a continuation of U.S. application Ser. No. 10/756,015 filed on Jan. 13, 2004 and abandoned. In addition, this application is a continuation-in-part of U.S. patent application Ser. No. 11/167,535 filed on Jun. 27, 2005 currently pending, which is a continuation-in-part of U.S. patent application Ser. No. 10/756,015 filed on Jan. 13, 2004 and abandoned.

### FIELD OF THE INVENTION

The present invention relates to a novel type of storage battery which is distinguished by its unique electrochemistry. The positive electrode comprises lead dioxide and the negative electrode zinc. The electrolyte consists of an aqueous solution of an alkali metal sulphate salt. Various buffering agents, including carbonates, borates, silicates, and phosphates, may be added to the electrolyte. Upon discharge the lead dioxide is reduced to a divalent lead compound and zinc is oxidized to zinc oxide.

### BACKGROUND OF THE INVENTION

The most common storage battery, found in almost every vehicle, is the lead-acid battery. This battery comprises a lead dioxide positive electrode, a lead metal negative electrode, and sulphuric acid for the electrolyte. Its chief advantage is low cost. Nevertheless, it has limited energy density and the electrolyte is extremely corrosive. Furthermore, sufficient acid is required to react with the electrodes during discharge. Maintenance-free types avoid the loss of evolved gases, as disclosed in U.S. Pat. No. 3,862,861, but their cycle-life is still restricted.

The search for alternatives to the lead-acid battery has been ongoing. As far back as 1934, Drumm disclosed the nickel oxide-zinc battery and the silver oxide-zinc battery. (U.S. Pat. No. 1,955,115) Both of these batteries employ zinc as the negative electrode and caustic potash as the electrolyte. Nickel oxide or silver oxide serves as the positive electrode. These batteries have improved energy densities and for many uses are a good compromise.

The ideal storage battery would combine the best features of existing batteries with none of the drawbacks. The need for such a battery is apparent for backup power systems and in mobile applications. Therefore, it is an object of the present invention to provide an improved storage battery, one that is both economical and highly efficient. These and other objects, features, and advantages of the invention will be recognized from the following description and the accompanying FIGURE.

### SUMMARY OF THE DISCLOSURE

A storage battery is fabricated from a positive electrode of lead and a negative electrode of zinc. During charging, some lead is converted to lead dioxide. Upon discharge, lead dioxide is reduced to a divalent lead compound, more particularly, lead sulphate. Zinc is oxidized to zinc oxide. These reactions are reversible such that the battery fulfills both functions of a secondary battery: supplying electricity on demand and storing or accumulating surplus electricity.

The electrolyte of the cell is an aqueous solution of a salt selected from the group of alkali metal sulfates. The alkali metals include lithium, sodium, potassium, rubidium, and cesium. Any combination of these metals may be used.

Certain additives have been found to be effective buffers in the electrolyte. These additives include bicarbonates, carbonates, borates, silicates, and phosphates.

The electrodes of a practical embodiment of the invention may be configured as sheets, fibers, or particles, thereby to maximize the electrode surface area. Interspersed particles of a carbonaceous material may be used to improve the electrical conductivity. A gelling agent may be added to immobilize the electrolyte. As required, a separator may be employed between the positive and negative electrodes to prevent a short circuit.

### BRIEF DESCRIPTION OF THE DRAWING

FIG. 1 is a rendering of a prototype of a lead-zinc battery according to the present invention, illustrating the principal components of the cell.

### WRITTEN DESCRIPTION

The chemistry of the lead-zinc battery is important in order to gain an understanding of its operation. A positive electrode comprises lead dioxide, which is reduced to divalent lead sulphate during discharge. The negative electrode comprises zinc, which is oxidized to zinc oxide when the cell is discharged. The electrolyte is an aqueous solution of an alkali metal sulphate. In the special case where the alkali metal is potassium, the electrode reactions during discharge can be represented by the following equations.

Positive electrode:

PbO₂+K₂SO₄+2H₂O+2e→PbSO₄+KOH+2OH (1)

Negative electrode:

Zn+2OH→ZnO+H₂O+2e (2)

When these equations are combined, the overall reaction for the cell is obtained as follows:

PbO₂+Zn+K₂SO₄→PbSO₄+ZnO+2KOH (3)

During recharging of the cell, the reactions are reversed. Thus, lead sulphate is oxidized to lead dioxide and zinc oxide is reduced to zinc metal. The emf necessary for charging is supplied by an external power source. The discharge-recharge cycle can be repeated endlessly, thus fulfilling the function of a storage battery.

A particularly difficult challenge in designing new batteries is identifying electrode materials that will undergo electrochemical reactions and still withstand corrosion by the electrolyte. Although theory is helpful in this respect, empirical data are required to prove the effectiveness of materials—both for the electrodes and the electrolyte. One measure of the relative performance of a cell is the open-circuit voltage.

In its choice of electrolyte, the present invention has a decided advantage. Instead of using an electrolyte comprising a strong alkali like potassium hydroxide or a strong acid like sulphuric acid, the present invention employs an aqueous solution of a salt. Such an electrolyte is a good ionic conductor but is relatively mild tinder operating conditions. It therefore avoids problems of electrode corrosion that plague existing batteries.

Notwithstanding the superior performance of the electrolyte of the present invention, there may be a need for better control over the pH of the solution. In this case, a buffering agent may be added to the electrolyte. Such compounds as carbonates, borates, silicates, and phosphates can be effective in this application. These salts have the added benefit of forming insoluble compounds with the lead and zinc.

The selection of the alkali metal sulphate for use in the electrolyte is of some interest. Sulfates of any one of the alkali metals can be used, including lithium, sodium, potassium, rubidium, and cesium. As one progresses from lithium to cesium in this series, the electronegativity decreases. This phenomenon will effect the ionic nature of the salts, and therefore can be expected to influence the battery's performance. The sulfate salt used as the electrolyte can also be tetramethylammonium sulfate.

Another factor in considering the choice of alkali metal is the solubility of its sulphate. For example, the solubility of potassium sulphate at 0° C. is 7.35 gm. Per 100 ml. water, whereas the solubility of lithium sulphate at the same temperature is 35.34 gm. Greater solubility has an advantage by aiding the compactness of the battery.

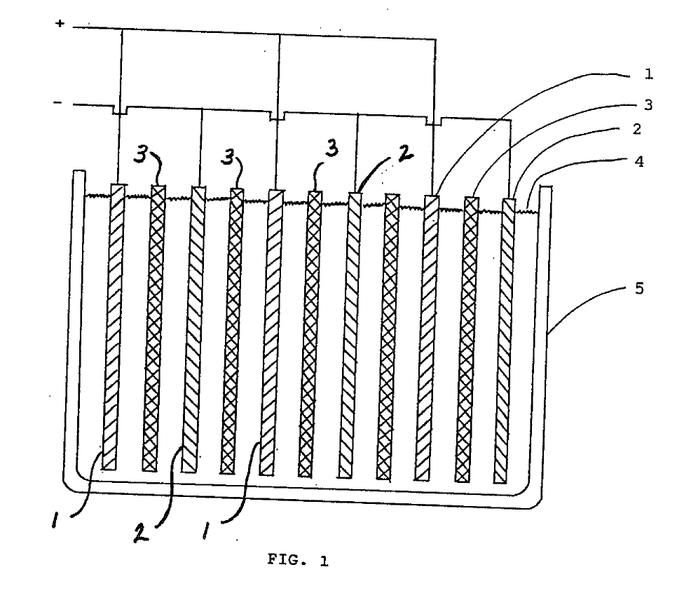

The configuration of a lead-zinc cell of the present invention is not restricted. The distinctive features, however, can be appreciated from a drawing of a prototype as shown in FIG. 1. The cut-away perspective shows the electrodes arranged as flat parallel plates. The lead positive electrodes 1 and the zinc negative electrodes 2 are kept apart by separators 3. These parts are immersed in the electrolyte 4, which is contained in casing 5. This sectional view also shows the electrical leads attached to the electrodes.

### Examples

(1) A cell was fashioned from a glass jar 2.5 in. diameter by 4 in. high. A plastic divider kept the electrodes apart. The positive electrode was a strip of lead 1.5 in. wide by 4 in. high. The negative electrode was a strip of zinc 1.5 in. wide by 4 in. high. The electrolyte was prepared by dissolving 44.1 gm. Of sodium sulphate 99.0% minimum in 200 ml. of water. After charging the cell for 25 minutes at 3.0 volts, an open circuit potential of 2.75 volts was observed. The cell was discharged through a loop containing a flashlight bulb producing a current of 95 milliamps.

(2) The same cell as used in example (1) was employed. In this run, an electrolyte was formulated by dissolving 45.1 gm. lithium sulphate monohydrate 99.0% minimum in 200 ml. of water. An open circuit potential of 2.72 volts was obtained after charging the cell for 25 minutes at 3.0 volts. The cell produced a current of 92 milliamps through the same circuit as used in example (1).

(3) The cell used in this experiment was assembled from a glass jar 1.75 in. diameter by 4 in. high with a plastic divider to keep the electrodes separated. The electrodes were identical to those used in examples 1 and 2. The electrolyte consisted of 15.6 gm. of cesium sulphate 99.9% dissolved in 100 ml. water. After charging the cell for 11 minutes at 3.2 volts, an open circuit potential of 2.55 volts was achieved. The maximum current produced by the cell was 80 milliamps through the same loop as before. At the end of all three runs described in examples 1, 2, and 3, the electrodes were in excellent condition, showing no signs of corrosion.

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A storage battery comprising:
a. a positive electrode of lead;
b. a negative electrode of zinc; and
c. an electrolyte comprising an aqueous solution of a salt selected from the group of alkali metal sulfates.

2. The storage battery according to claim 1 in which the alkali metal is lithium.

3. The storage battery according to claim 1 in which the alkali metal is sodium.

4. The storage battery according to claim 1 in which the alkali metal is potassium.

5. The storage battery according to claim 1 in which the alkali metal is rubidium.

6. The storage battery according to claim 1 in which the alkali metal is cesium.

7. The storage battery according to claim 1 in which the alkali metal is tetramethylammonium.
